(19) United States
(12) Patent Application Publication
(10) Pub. No.: US 2003/0121694 A1
(43) Pub. Date: Jul. 3, 2003

(54) Flexible electric cable

(75) Inventors: Ferdinand Grogl, Nuernberg (DE); Thomas Mann, Weissenohe (DE)

Correspondence Address: SUGHRUE MION, PLLC, 2100 Pennsylvania Avenue, NW, Washington, DC, 20037-3213, US

(73) Assignee: NEXANS

(21) Appl. No.: 10/323,890

(22) Filed: Dec. 20, 2002

(30) Foreign Application Priority Data
Dec. 20, 2001 (DE) 10162739.4

(51) Int. Cl. H01B 11/02

(52) U.S. Cl. 174/113 R

(57) ABSTRACT

A flexible electric cable, in particular a robotic cable, having a core and a sheathing surrounding the core made of plastic. The core contains at least one energy line or power line (1), at least one line (2, 3) for transmitting high-frequency signals, at least one line for transmitting low-frequency signals, or a control line (4).

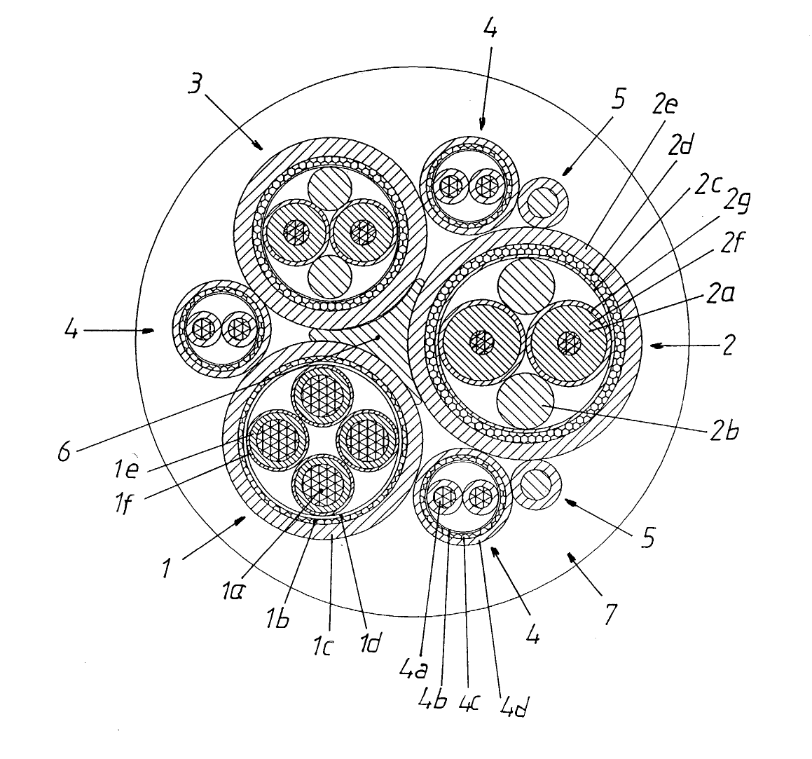

This application is based on and claims the benefit of German Patent Application No. 10162739.4 filed Dec. 20, 2001, which is incorporated by reference herein.

### BACKGROUND OF THE INVENTION

The invention relates to a flexible electric cable according to the preamble of claim 1.

Cables having a high degree of flexibility and reversed bending fatigue strength are required for the control of modern robotic and handling systems. Such cables are constantly in motion during operation, and must withstand torsions of ±440° during continuous operation.

A highly flexible cable for use with modern robots is known from the periodical “Elektrotechnik” [Electrical Engineering], October 2000, Vol. 82, in which multiple individual cables are housed in a hybrid cable. Thus, for example, six individual cables are housed in a hybrid cable, specifically, three thicker cables for the more powerful motors and three thinner cables for the less powerful motors. The individual cables are stranded together as a unit about a conductive core. In order to keep the friction on the individual modular units as low as possible, these modular units have low-friction insulation surfaces in addition to complicated banding. Insulation materials based on polyurethane are preferred which are resistant to abrasion as well as to hydraulic fluid and mineral oil. Thermoplastic elastomers are used as sheathing material so that the sheathing is notch-proof and chafe-resistant. Control lines may also be housed in the cable.

### SUMMARY OF THE INVENTION

An object of the present invention is to provide a flexible electric cable, in particular for use in robotic systems, which enables power, control signals, and data to be transmitted.

This object is achieved by the features described in the characterizing part of claim 1.

Using the combined cylindrical cable, which in addition to the power supply lines and control lines thus far known also now contains data lines, one or several additional data cables may be omitted, which is particularly advantageous because of the restricted spaces in robotic systems.

According to one advantageous refinement of the invention, the lines in the core are stranded together in the same direction of lay and with coordinated lay length in such a way that the lay-up angles of all lines in the core are essentially equal, and the lines thus have the same length.

It is also advantageous if the sheathing is an interstice-filling injection-molded sheathing made of an abrasion-resistant, oil-resistant, flameproof plastic. Thermoplastic polyurethane, thermoplastic elastomer (known by the trade name Santoprene), halogen-free polymer compound, or polyvinyl chloride are particularly preferred here. Filling the interstice causes the individual lines in the strand assembly, that is, in the cable core, to be fixed in relation to one another. So-called corkscrew formation is thus avoided.

Alternatively, a wrapping made of a synthetic nonwoven fabric may be provided over the core which is glued to the sheathing made of thermoplastic polyurethane, TPE, halogen-free polymer compound, or polyvinyl chloride. The synthetic non-woven fabric allows the sheathing to slide with respect to the core, thus improving the flexibility.

Each line in the core has its own shielding in order to avoid a mutual electromagnetic influence from the individual lines in the strand assembly.

Each shielded line has an injection-molded outer layer made of a thermoplastic polyurethane or polypropylene modified to enable sliding. This improves the flexibility of the cable, since the individual lines can slide with respect to one another virtually unhindered.

Symmetrical bus lines known in the field of process automation, such as Profi-Bus (for high data rates) with a 150-Ohm surge resistance (at 1 to 10 MHz) and CAN bus (for average data rates) with a 120-Ohm surge resistance (at 0.5 to 1 MHz), are used as lines for the transmission of average and high data rates (100 kBaud to 1 MBaud).

In contrast to the known construction designs for bus lines, an insulation material (foam-skin or skin-foam-skin) having at least a 2-ply design is used with modified PP foam material which can be physically or chemically foamed. The outer, hard insulation layer thus ensures slidability of the lead.

Another advantage compared to known designs is the special 2-ply shield construction for the Profi-Bus and the Can bus. This shield comprises a first layer made of copper bands wound in an overlapping manner which are coiled onto a sliding film which encloses the cable core, and a second layer made of copper wire winding.

The overlapping wrapping achieves a reliable shielding effect, even when the line is under torsional stress. The stranded winding made of Cu wires or tin-plated Cu wires fixes the tape lapping without impairing the torsional characteristics, and contributes to a marked improvement in the shielding properties (coupling resistance or shield damping).

Instead of the aforementioned bus lines, multipair symmetrical 100 MBit ethernet cables with a 100-Ohm surge resistance (at 1 to 100 MHz) can be used for extremely high data rates.

The core also contains three low-frequency lines, each of which contains a pair of leads. These low-frequency lines also have shielding, which is made of a copper wire winding that is coiled onto a separating film or sliding film made of polytetrafluoroethylene.

The Profi-Bus and the CAN Bus each comprise two foam-insulated conductors which are two fillers situated in the interstices to ensure defined electrical properties and compressibility of the bus lines in a cylindrical design.

However, the Profi-Bus as well as the CAN bus may also have an interstice-filling inner sheathing made of a plastic with a low dielectric constant, preferably a foamed material such as modified cellular PE, for example. Of course, with this approach the fillers are omitted.

It is preferable for a core element made of a compressible material to be situated in the center of the core. This feature also improves the flexibility and torsional characteristics of the cable.

### BRIEF DESCRIPTION OF THE DRAWINGS

The invention is explained in more detail with reference to the exemplary embodiments illustrated in the FIGURE.

### DETAILED DESCRIPTION OF THE INVENTION

The FIGURE illustrates a section through a robotic cable having a core comprising a power transmission line 1, a Profi-Bus line 2, a CAN bus line 3, and three low-frequency lines 4. In addition, two ground wires 5 and a core element 6 made of a compressible material are situated in the core. The core is surrounded by a plastic sheath 7 which is injection-molded onto the core so as to fill the interstices, or which is injection-molded onto a non-woven fabric winding, not shown, which encloses the core and is glued to the non-woven fabric winding.

A power line 1, two data lines 2 and 3, and three control lines 4 are combined within the robotic cable.

Core element 6 may, e.g., also be a cord, not shown, injection-molded with a foamed material.

Lines 1, 2, and 3 are stranded about core element 6 in such a way that all lines have the same direction of lay, and the lay lengths are coordinated so that all lines 1, 2, and 3 have the same length.

Low-frequency lines 4 are situated in the respective interstices of lines 1, 2, and 3.

Outer sheathing 7 is preferably made of thermoplastic polyurethane which is flameproof and halogen-free.

Power line 1 comprises, for example, four leads 1a which are enclosed by shield 1b made of a wire strand, the shield in turn being surrounded by a plastic layer 1c. Plastic layer 1c is made of a slidable, injection-moldable plastic, preferably modified polypropylene. A sliding film 1d, for example a PTFE film, is also provided between leads 1a and shielding 1b. The insulation for leads 1a comprises an inner, soft layer 1e made of polypropylene foam and an outer, hard layer 1f made of polypropylene.

Each low-frequency line 4 comprises two leads 4a stranded together. The lead pair is enclosed by a sliding film 4b, shielding 4c, and an outer layer 4d made of an injection-moldable, slidable plastic such as polypropylene. Shielding 4c comprises a winding made of copper wires.

Data transmission line 2 comprises two insulated leads 2a and two fillers 2b. Leads 2a and the two fillers 2b are surrounded by a sliding film 2c and shielding 2d made of copper bands wound in an overlapping manner, and of a stranded winding of copper wires which can be tin-plated. The term “overlapping” is understood to mean a wrapping comprising a first band wound by the distance separating the band edges, and a second band which overlaps the distance separating the band edges. The design of outer layer 2e is the same as that of outer layer 1c of line 1, or of outer layer 4d of lines 4. High-frequency line 2 has an impedance of 150 Ω. In addition, it is important that the insulation for leads 2a have a two-ply design, specifically, a design comprising an inner layer 2f made of polypropylene foam and an outer layer 2g made of polypropylene.

Data transmission line 3 (CAN bus) has a similar design except that the dimensions of the elements are smaller, with the result that this line 3 has an impedance of 120 Ω.

What is claimed is:

1. A flexible electrical cable, in particular a robotic cable, having a core and a sheathing surrounding the core made of plastic, wherein the core contains at least one energy line or power line (1), at least one line (2) for transmitting high-frequency signals, at least one line for transmitting low-frequency signals, or a control line (4).

2. A flexible electrical cable according to claim 1, wherein the lines (1, 2, 3, 4) in the core are stranded together in the same direction of lay and with coordinated lay length in such a way that the lay-up angles of all the lines (1, 2, 3, 4) in the core are essentially equal and the lines (1, 2, 3, 4) have the same length.

3. A flexible electrical cable according to claim 1, wherein the sheathing (7) is an interstice-filling injection-molded sheathing made of an abrasion-resistant, oil-resistant, flameproof plastic such as thermoplastic polyurethane or polyvinyl chloride.

4. A flexible electrical cable according to claim 1, wherein a wrapping made of synthetic nonwoven fabric is provided over the core which is glued to an injection-molded sheathing (7) made of thermoplastic polyurethane or polyvinyl chloride.

5. A flexible electrical cable according to claim 1, wherein each line (1, 2, 3, 4) of the core has its own shielding (1b, 2d, 4c).

6. A flexible electrical cable according to claim 1, wherein each shielded line (1, 2, 3, 4) of the core has an injection-molded outer layer (1c, 2e, 4d) made of a thermoplastic polyurethane or polypropylene modified to enable sliding.

7. A flexible electrical cable according to claim 1, wherein the core contains a Profi-Bus (2), a CAN bus (3), a four-lead line (1) for power transmission, and three low-frequency lines (4) each containing a lead pair.

8. A flexible electrical cable according to claim 6, wherein the Profi-Bus (2) and the CAN bus (3) have shielding (2d) made of copper bands wound in an overlapping manner or of copper/plastic-copper sandwich films wound in an overlapping manner, as well as a stranded winding situated over the shielding, made of copper wires or tin-plated copper wires.

9. A flexible electrical cable according to claim 7, wherein the Profi-Bus (2) and the CAN bus (3) comprise two foam-insulated conductors (2a) and at least two fillers (2b), and the structure comprising the foam-insulated conductors (2a) and the fillers (2b) has a wrapping (2c) made of plastic non-woven fabric.

10. A flexible electrical cable according to claim 1, wherein the Profi-Bus (2) and the CAN bus (3) comprise two foam-insulated conductors (2a) which are surrounded by an interstice-filling inner sheathing made of a plastic with a low dielectric constant or made of foamed plastic.

11. A flexible electrical cable according to claim 1, wherein the low-frequency lines (4) are situated in the strand interstices between the Profi-Bus (2), the CAN bus (3), and the four-lead line (1) for power transmission.

12. A flexible electrical cable according to claim 1, wherein a compressible core element (6) is situated in the center of the core.

13. A flexible electrical cable according to claim 1, wherein in the power line (1) and the lines for the transmission of high-frequency signals (2, 3), the insulation layer for the conductors has a two-ply design, specifically, a soft, inner layer and a hard, outer layer.

14. A flexible electrical cable according to claim 13, wherein the inner, soft layer is made of foamed polypropylene and the outer, hard layer is made of unfoamed polypropylene.
